(19) United States
(12) Patent Application Publication
(10) Pub. No.: US 2008/0120407 A1
(43) Pub. Date: May 22, 2008

(54) TRACKING USAGE OF PORTABLE MEDIA DEVICE

(75) Inventors: Michael A. Chen, Wallingford, PA (US); Ty O. Ahmad-Taylor, New York, NY (US)

Correspondence Address: BROOKS KUSHMAN P.C., 1000 TOWN CENTER, TWENTY-SECOND FLOOR, SOUTHFIELD, MI, 48075, US

(73) Assignee: COMCAST CABLE HOLDINGS, LLC, Philadelphia, PA (US)

(21) Appl. No.: 11/560,917

(22) Filed: Nov. 17, 2006

(51) Int. Cl. G06F 15/16; G06Q 30/00

(52) U.S. Cl. 709/224; 705/10

(57) ABSTRACT

Tracking usage of portable media device such that usage information associated with the media device may be tracked while the media device is offline. The usage information may relate to any number operating parameters and conditions of the media device, including media consumption and usage information.

### BACKGROUND OF THE INVENTION

1. Field of the Invention

The present invention relates to tracking usage information for a portable media device.

2. Background Art

The ability to track customer habits, preferences, actions, and other characteristics allows service providers to enhance products and other valuable services while also allowing the service provider the ability to specify advertisements and define other customer specific interactions. In some mediums, such as but not limited to portable media devices, the service provider may be unable to track such usage information when the associated media device is offline or otherwise unable to communicate with the service provider.

### BRIEF DESCRIPTION OF THE DRAWINGS

The present invention is pointed out with particularity in the appended claims. However, other features of the present invention will become more apparent and the present invention will be best understood by referring to the following detailed description in conjunction with the accompany drawings in which:

FIG. 1 illustrates a system for tracking usage associated with a media device in accordance with one non-limiting aspect of the present invention; and

FIG. 2 illustrates a method of tracking usage information in accordance with one non-limiting aspect of the present invention.

### DETAILED DESCRIPTION OF THE PREFERRED EMBODIMENT(S)

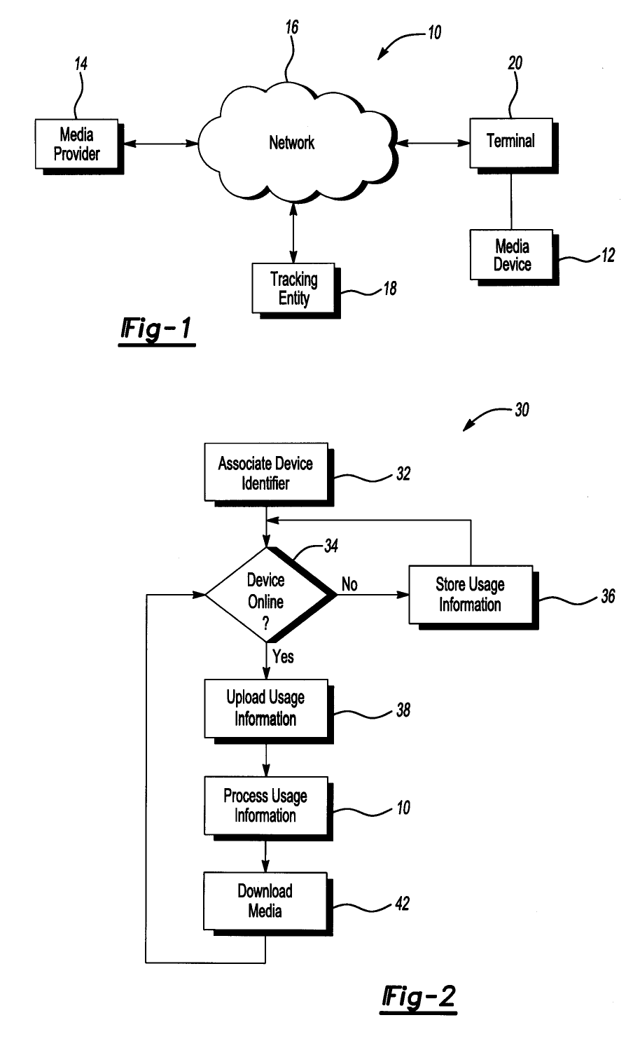

FIG. 1 illustrates a system 10 for tracking usage associated with a media device 12 in accordance with one non-limiting aspect of the present invention. The system 10 may generally related to system associated with a media provider 14 having capabilities to provide any number of services to a customer associated with the media device 12. A network 16 may be included to interface the media device 12 with the services associated with the media provider 14. A tracking entity 18 may be included to track information associated with the usage of the media device 12.

The media provider 14, for exemplary purpose, is most prominently described with respect to being a cable television service provider having capabilities for providing cable television, telecommunications, and high-speed data services to the customer locations, primarily through wired and/or wireless communications. The present invention, however, is not so limited and fully contemplates the provider being associated with any type of service provider, including other television providers (IP, broadcast, satellite, etc.) and non-television providers, such as those associated with high-speed data, telecommunications, cellular/mobile communications, and the like.

The media provider 14 may be configured to support and/or facilitate the use of any number of television and non-television services and applications, such as, but not limited to email services, data transmission service, linear and non-linear television programming/signaling (cable, satellite, broadcast, etc.), Video on Demand (VOD), interactive television (iTV), interactive gaming, pay-per-view (PPV), digital video recording (local and remote), and/or broadcasting of signals associated with supporting television programming, movies, audio, and other multimedia, as well as, downloading of clips or full-length versions of the same. The messages associated with these and any number of other services may be limited in accordance with the present invention.

The network 16 may include any number of features and devices to facilitate signal transportation and other operations associated with interfacing the customer locations with each other and otherwise supporting communications associated with services of the media provider 14. The network 16 may include terrestrial and extraterrestrial components and infrastructures, including cable lines, telephone lines, and/or satellite or other wireless architectures. The network 16 may be associated with other private and/or public networks, such as the Internet and dedicated or virtual private networks.

The services associated with the media provider 14 may be facilitated through communications and other signaling from any number of content sources (not shown). For example, if the media provider 14 is a television service provider, a portion of the media content may relate to television programs, movies, and other multimedia packets. This content may be delivered from the media service provider to the customer through streaming, downloading, broadcast, peer-to-peer, and any number of other processes.

The media content may be delivered to the customer locations directly from the media service provider 14 and/or from one or more of the other devices in communication therewith. As is common with larger media content providers, multiple regional enterprises, such as headend units and the like, may be configured to provide regional programming to a number of customers associated therewith. Each of the headends may store various types of media content for distribution to the customers it services. Optionally, the headends may be configured to support headend to headend communications such that non-direct customers, i.e., those supported by other headends, may similarly receive content from other headends.

In addition, some of the media content may be sourced from the customers themselves, such as by transporting content stored locally on the home networks of the customers to other locations within the same home network and/or to other locations beyond the home network that are in communication therewith by way of the network. The media provider may include features and capabilities to facilitate such inter-customer communications.

The tracking entity 18 may be a standalone entity and/or otherwise associated with the media provider 14. It may include memories, processors, and communication capabilities necessary to executing the operations of the present invention. The tracking entity 18 may be configured to monitor usage information associated with usage of the media device 12. The usage information may include information associated with any number of operating parameters of the media device and/or consumption of the media device, i.e., services accessed, advertisements watched, program selected, etc.

The media device 12 may relate to any number of devices suitable for interfacing and/or facilitating interfacing customers with the media provider 14 and associated services. Optionally, the media device 12 may be of the type that requires a communication terminal 20 and/or other feature to facilitate communications with the network 16 and signaling carried over the network 16. The communication terminal 20 may be a docking station, computer, modem, and/or other feature having capabilities to facilitate electronic communications with the media device 12.

The media device 12 may be an audio/video player, personal computer (PC), mobile device (phone, computer, etc.), personal media device, and any other item having capabilities to support customer access to any number of the services. The media device 12 may be characterized as a device having an online and offline state in so far as its ability to communicate with network or elements associated with the network may be limited as function of whether the device is online or offline.

In the online state, the media device 12 may be able to communicate with the network 16, either on its own and/or with the assistance of the terminal 20. In the offline state, the media device 12, for any number of reasons and/or because it is disconnected from the terminal 20, may be unable to communicate with the network 16. The ability to communicate or not communicate with the network 16 influences the ability of the tracking entity to track usage information associated with the media device 12.

When the media device 12 is online, the tracking entity 18 may communicate with the media device 12 to ascertain and/or monitor the usage associated with the media device 12. When the media device 12 is offline, the tracking entity 18 is unable to perform the desired tracking such that the media device 12 may be configured in accordance with the present invention to store usage information under such conditions. The information can then be subsequently retrieved by the tracking entity 18 during the next online session or other operation. In this manner, the present invention is able to track usage information for the media device 12 during offline operations.

FIG. 2 illustrates a flowchart 30 of a method of tracking usage information in accordance with one non-limiting aspect of the present invention. The method or portions thereof may be coordinated through instructions and/or other logically functioning aspects of the usage tracking entity, the media provider, media device, or any other element having capabilities suitable to the purposes of the present invention. The method is predominately described with respect to a mobile media device configured to facilitate playback of downloaded media content. The present invention, however, is not intended to be so limited and fully contemplates its use and application in any number of environments.

Block 32 relates to associating a device identifier with the media device. Multiple media device identifiers may be associated with any number of media devices associated with the media provider. The method is described with respect to a single media device, but the present invention is not so limited and fully contemplates supporting usage tracking for any number of media devices. The device identifier may be used to identify the device and/or a user associated with the device. The usage tracking entity may include information to facilitate identifying and associated the media device with the media device identifier.

Block 34 relates to determining whether the device is online or offline. This determination may be made in any manner sufficient to trigger the media device to store its own usage information when offline. One method may include programming the media device to automatically store usage information when offline and/or in response to a signal or other element communicating with the media device just before being disconnected from the network, such as but not limited to the communication terminal adjusting a MIB setting or other setting of the media device during a disconnect operation.

Optionally, the usage tracking entity may be configured to monitor connection states of the media device. This information may be helpful with other operations associated with the system, such as supporting downloads and other information exchange with the media device. After a predefined period of time or some other trigger event, the tracking entity may be configured to check for re-connection of the media device and/or the media device may announce itself when re-connected.

The usage information stored by the media may relate to any number of operating parameters of the device, such as but not limited to device settings, software configurations, hardware status, memory capacities, and any number of other characteristics associated with the device and/or associated with features used to facilitate operations of the device. The usage information may also relate to non-device specific information, such as but not limited to media consumption (accessed, downloaded, viewed, not viewed, time viewed, etc.), viewing habits (genre, title, rating, etc.), preferences, recommendations, and any number of other characteristics.

Block 36 relates to determining the media device to be offline and storing usage information locally on the media device. The media device may be determined to be offline under any number of circumstances. In general, the media device may be considered to be offline if the media device is unable to upload usage information and/or if the tracking entity is unable to receive, track, or otherwise store the usage information such that a need exists for the usage information to be tracked and stored by the media device. The media device may be a device, such as but not limited to a portable media unit that is only able to communicate with the network when connected to a terminal such that the media device may be considered to be offline when the media device is unable to communicate with the network or otherwise exchange signals therewith.

Block 38 relates to determining the media device to be online. This may occur after the offline media device is re-connected to the network and/or if the media device was never disconnected. The online state is generally characterized to correspond with the ability of the device to communicate with the tracking entity such that the online status may be determined in any manner sufficient to assess the same, such as but not limited to announcements generated by the media device, polling response of the media device, etc.

If the media device was previously online, the tracking entity may already possess sufficient tracking information for the media device, either through previous information uploads and/or through other monitoring of the media device. If the media device was not previous online and/or if the information stored on the media device nonetheless is desired by the tracking entity, the media device may be instructed to upload the stored usage information. The uploading may correspond with a file transfer or other operation(s) sufficient to appraise the tracking entity of the usage information.

Block 40 relates to the tracking entity processing the acquired usage information. The processing may include associating the usage information with the corresponding device identifier. Billing, system upgrading, advertisement selection, recommendation compilations, viewing habits, and any number of other characteristics or features tracked with the usage information may be updated in response to receipt of the new usage information.

Block 42 relates to downloading media to the media device as a function of the uploaded usage information. This may include the media device requesting downloading and/or the tracking entity instigating downloading. One example may relate to the media device requesting downloading of a video clip or other media. Advertisements and other features may be included with the downloaded media as function of the acquired usage information, including the usage information acquired while the media device was offline. This may be helpful in selecting advertisement to correspond with advertisement watched by the user when the media device was previously offline.

The ability of the present invention to correspond or otherwise facilitate media downloading and similar operations as a function of usage information collected while the media device was offline, allows the present invention to enhance advertising, recommendations, content selection, service upgrades, billing, and any number of other operations as the service provider is now able to assess any number of conditions occurring while the media device is offline.

As such, the present invention is able to provide collected usage tracking information, for example to information an advertising business model and operation. This may assist construction of such a model with exiting compatible device and/or may guide development of new portable media devices to accommodate such usage.

As required, detailed embodiments of the present invention are disclosed herein; however, it is to be understood that the disclosed embodiments are merely exemplary of the invention that may be embodied in various and alternative forms. The figures are not necessarily to scale, some features may be exaggerated or minimized to show details of particular components. Therefore, specific structural and functional details disclosed herein are not to be interpreted as limiting, but merely as a representative basis for the claims and/or as a representative basis for teaching one skilled in the art to variously employ the present invention.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A method for tracking usage of a portable media device, the method comprising:
storing usage information associated with usage of the media device on a memory of the media device when the media device is offline; and
transferring the stored media usage information from the media device to a tracking entity when the media device is online.

2. The method of claim 1 further comprising determining the media device to be offline when the tracking entity is unable to communicate with the media device.

3. The method of claim 1 further comprising determining the media device to be offline when the media device is disconnected from a communication source used to communicate with the usage tracking entity.

4. The method of claim 1 further comprising storing media usage information for media downloaded to the media device when the media device is online.

5. The method of claim 1 further comprising tracking media usage information for advertisements viewed when the media device is offline.

6. The method of claim 5 further comprising downloading the tracked advertisements to the media device when the media device is online.

7. The method of claim 6 further comprising selecting the advertisements downloaded to the media device as a function of the media usage information stored on the media device.

8. The method of claim 7 further comprising uploading the stored media usage information from the media device to the tracking entity for use by the tracking entity in selecting future advertisement downloaded to the media device.

9. The method of claim 7 further comprising including a media device identifier with the media usage information and selecting the advertisements downloaded to the media device as a function of the media device identifier.

10. The method of claim 9 further comprising identifying a user of the media device as a function of the media device identifier and selecting the advertisements to correspond with the user.

11. The method of claim 9 further comprising identifying capabilities of the media device as a function of the media device identifier and selecting the advertisement to correspond with the capabilities of the media device.

12. A system for tracking media usage comprising:
a portable media device configured for storing media usage information associated with usage of the media device on a memory when the media device is offline; and
a tracking entity configured for receiving the stored media usage information from the media device to when the media device is online.

13. The system of claim 12 wherein the media device is unable to electronically communicate with the tracking entity unless the media device is connected to a communication terminal such that the media device is offline when disconnected from the terminal and online when connected to the terminal.

14. The system of claim 12 wherein the media device is unable to electronically communicate when disconnected from a non-portable communication terminal such that the media device offline when disconnected from the terminal.

15. The system of claim 14 wherein the non-portable communication terminal is a docking station such that typically usage of the media device occurs when the media device is disconnected from the docking station.

16. The system of claim 12 wherein the media devices stores media usage information for advertisements viewed when the media device is offline.

17. The system of claim 16 wherein the tracking entity selects advertisements downloaded to the media device as a function of usage information collected from the media device for advertisements previously downloaded to the media device.

18. The system of claim 17 wherein the media device includes a media device identifier with the media usage information and wherein the tracking entity selects the advertisements downloaded to the media device as a function of the media device identifier.

19. The system of claim 18 wherein media device identifier identifies a user of the media device and wherein the tracking entity selects the advertisements to correspond with the user.

20. The system of claim 18 wherein media device identifier identifies capabilities of the media device and wherein the tracking entity selects the advertisements to correspond with the capabilities of the media device.
